(19) United States
(12) Patent Application Publication
(10) Pub. No.: US 2017/0310891 A1
(43) Pub. Date: Oct. 26, 2017

(54) IMAGE PROCESSING APPARATUS, IMAGE PROCESSING METHOD AND STORAGE MEDIUM

(71) Applicant: CANON KABUSHIKI KAISHA, Tokyo (JP)

(72) Inventor: Hideyuki Ikegami, Yokohama-shi (JP)

(21) Appl. No.: 15/523,617

(22) PCT Filed: Oct. 22, 2015
(86) PCT No.: PCT/JP2015/005323

§ 371 Date: May 1, 2017

(30) Foreign Application Priority Data
Nov. 14, 2014 (JP) 2014-232193

(51) Int. Cl. H04N 5/232

(52) U.S. Cl. CPC H04N 5/23238; H04N 5/23222

(57) ABSTRACT

An image processing apparatus, including: an acquisition unit acquiring an image captured by an image capturing unit that can capture images while changing capturing directions by turning in a pan direction and a tilt direction; and a generating unit generating, using the images acquired by the acquisition unit, a panoramic image in a range capturable by the image capturing unit that turns in the pan direction and the tilt direction, wherein if an angle in the tilt direction of the image capturing unit to be turned during generation of the panoramic image straddles a turning axis of the pan direction, the generating unit sets a range of the angle in the tilt direction of the panoramic image to include a range from a tilt start point in the tilt direction to the turning axis in the pan direction, and not to include a tilt end point in the tilt direction.

### TECHNICAL FIELD

The present invention relates to a technique for generating a panoramic image in a range capturable with an image capturing apparatus using images generated with the image capturing apparatus which can capture images while changing capturing directions by panning/tilting.

### BACKGROUND ART

A technique for generating a panoramic image of the entire capturable range of a network camera with PTZ control has been proposed. PTL 1 discloses generating a panoramic image of the entire capturable range of a network camera. A related art method for generating a panoramic image, as disclosed in PTL 1, is described with reference to the drawings.

FIGS. 1A and 1B illustrate pan/tilt (PT) operations of a network camera. In FIGS. 1A and 1B, a network camera 1 is a network camera with PTZ control.

FIG. 1A illustrates the network camera 1 seen in the direction vertical to a turning direction of the pan operation. In FIG. 1A, the network camera 1 can turn in the directions of 101 and 102 in the pan operation with the angle (i.e., position) 100 (0°) as a reference. The direction 101 is defined as a negative (−) direction. The capturing direction can be changed as illustrated by 103 to the angle 104 (−170°). The direction 102 is defined as the positive (+) direction. The capturing direction can be changed as illustrated by 105 to the angle 106 (170°). That is, in the example illustrated in FIG. 1A, the network camera 1 can turn between 170° and −170° in the pan direction.

FIG. 1B illustrates the network camera 1 seen in the direction horizontal to a turning direction of the pan operation. In FIG. 1B, an image capturing unit of the network camera 1 can turn in the direction of 111 in the tilt direction (i.e., a direction crossing perpendicularly the pan direction) with the angle 110 (0°) as a reference. The direction 111 is defined as a negative (−) direction. The capturing direction can be changed as illustrated by 112 to the angle 113 (−90°). That is, the network camera 1 illustrated in FIG. 1B can turn between 0° and −90° in the tilt direction.

Next, a panoramic image generated when the network camera 1 illustrated in FIGS. 1A and 1B is installed in a room as illustrated in FIG. 9 is described with reference to FIG. 3. FIG. 9 illustrates exemplary installation of a network camera, illustrating that the network camera 1 is attached to a ceiling of a room (i.e., parallel to the pan direction). In FIG. 3, the reference numeral 200 denotes a panoramic image generated in accordance with images captured with the network camera installed as illustrated in FIG. 9.

The panoramic image 200 is obtained by combining the image sequentially captured while changing the capturing directions of the network camera 1 illustrated in FIGS. 1A and 1B in the pan/tilt directions. The reference numerals 3001 to 3004 denote images at specific pan/tilt angles (i.e., positions). The image 3001 is captured with the network camera 1 at −170° in the pan direction and 0° in the tilt direction. The image 3002 is captured at −170° in the pan direction and −90° in the tilt direction, the image 3003 is captured at 170° in the pan direction and 0° in the tilt direction, and the image 3004 is captured at 170° in the pan direction and −90° in the tilt direction with the network camera 1. In this manner, a panoramic image is generated by combining images covering a capturable range in pan/tilt directions.

In the network cameras with PTZ control, recently, a network camera with alleviated limitation in capturable angles in pan/tilt directions (which is referred to as a revolving unit) is proposed. Such a revolving unit can turn between 180° and −180° in the pan direction and between 0° and −180° in the tilt direction.

If a panoramic image is generated using images captured with an apparatus with a wide moving range, such as a revolving unit as described above, the following problems may occur. When a panoramic image corresponding to a range from 0° to −180° in the tilt direction is generated in accordance with the moving range of the revolving unit, an image corresponding to a range from 0° to −90° in the tilt direction and an image corresponding to a range from −90° to −180° in the tilt direction of the generated panoramic image overlap greatly. This makes a monitoring target to be displayed on two screens, or the like, causing difficulty in viewing. This is a phenomenon occurring because the moving range of the tilt direction straddles the turning axis of the pan operation. That is, if a panoramic image of the entire capturable range is generated when the moving range of the tilt direction of a PT camera straddles a turning axis of a pan direction, images overlap greatly.

### CITATION LIST

### Patent Literature

PTL 1: Japanese Patent Laid-Open No. 2000-101991

### SUMMARY OF INVENTION

As a technique for solving the above-described problems, a representative image processing apparatus has the following configuration.

An image processing apparatus, including: an acquisition unit configured to acquire an image captured by an image capturing unit that can capture images while changing capturing directions by turning in a pan direction and a tilt direction; and a generating unit configured to generate, using the images acquired by the acquisition unit, a panoramic image in a range capturable by the image capturing unit that turns in the pan direction and the tilt direction, wherein if an angle in the tilt direction of the image capturing unit to be turned during generation of the panoramic image straddles a turning axis of the pan direction, the generating unit sets a range of the angle in the tilt direction of the panoramic image to include a range from a tilt start point in the tilt direction to the turning axis in the pan direction, and not to include a tilt end point in the tilt direction.

Further features of the present invention will become apparent from the following description of exemplary embodiments with reference to the attached drawings.

The present invention reduces unnecessary overlapping areas during generation of a panoramic image from images captured with an image capturing unit which can capture images while changing capturing directions by panning/tilting.

### BRIEF DESCRIPTION OF DRAWINGS

FIG. 1A illustrates a pan operation of a network camera.

FIG. 1B illustrates a tilt operation of a network camera.

FIG. 2 is a block diagram illustrating an exemplary configuration of computer hardware applicable to a network camera system.

FIG. 3 illustrates a panoramic image of a network camera.

FIG. 4 is a block diagram illustrating a configuration of a network camera system in a first embodiment.

FIG. 5A illustrates the pan operation of the network camera in the first embodiment.

FIG. 5B illustrates the tilt operation of the network camera in the first embodiment.

FIG. 6 illustrates a flip operation of the network camera in the first embodiment.

FIG. 7 illustrates a flip angle of the network camera in the first embodiment.

FIG. 8A illustrates a state before and after the flip operation of the network camera in the first embodiment.

FIG. 8B illustrates a state before and after the flip operation of the network camera in the first embodiment.

FIG. 8C illustrates a state before and after the flip operation of the network camera in the first embodiment.

FIG. 8D illustrates a state before and after the flip operation of the network camera in the first embodiment.

FIG. 8E illustrates a state before and after the flip operation of the network camera in the first embodiment.

FIG. 8F illustrates a state before and after the flip operation of the network camera in the first embodiment.

FIG. 9 illustrates exemplary installation of a network camera.

FIG. 10 illustrates a panoramic image of the network camera in the first embodiment.

FIG. 11 is a flowchart of a generation process of the panoramic image in the first embodiment.

FIG. 12A illustrates a pan operation of a network camera in an operation mode.

FIG. 12B illustrates a tilt operation of a network camera in an operation mode.

FIG. 13 illustrates an exemplary panoramic image of a network camera in a normal mode.

FIG. 14 illustrates an exemplary panoramic image of a network camera in a limit mode.

FIG. 15 is a flowchart of a display process of the panoramic image in the first embodiment.

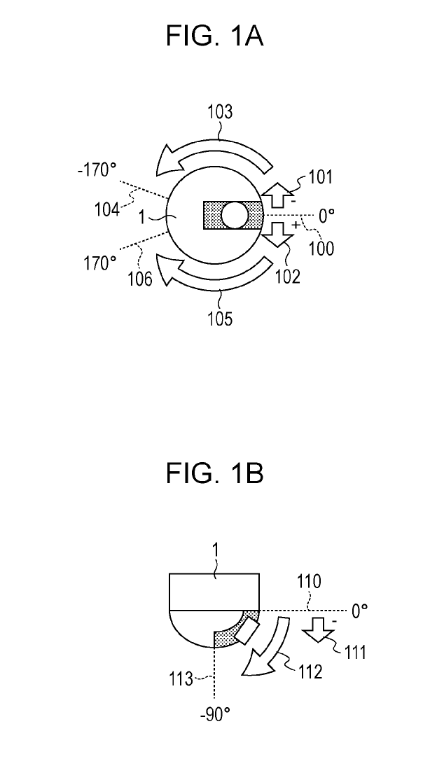

### DESCRIPTION OF EMBODIMENTS

Hereinafter, preferred embodiments of the present invention are described in detail with reference to the attached drawings. Configurations described in the following embodiments are illustrative only, and not restrictive. Camera server apparatuses (i.e., image capturing apparatuses) in the following embodiments may change their image capturing directions by turning in pan/tilt directions.

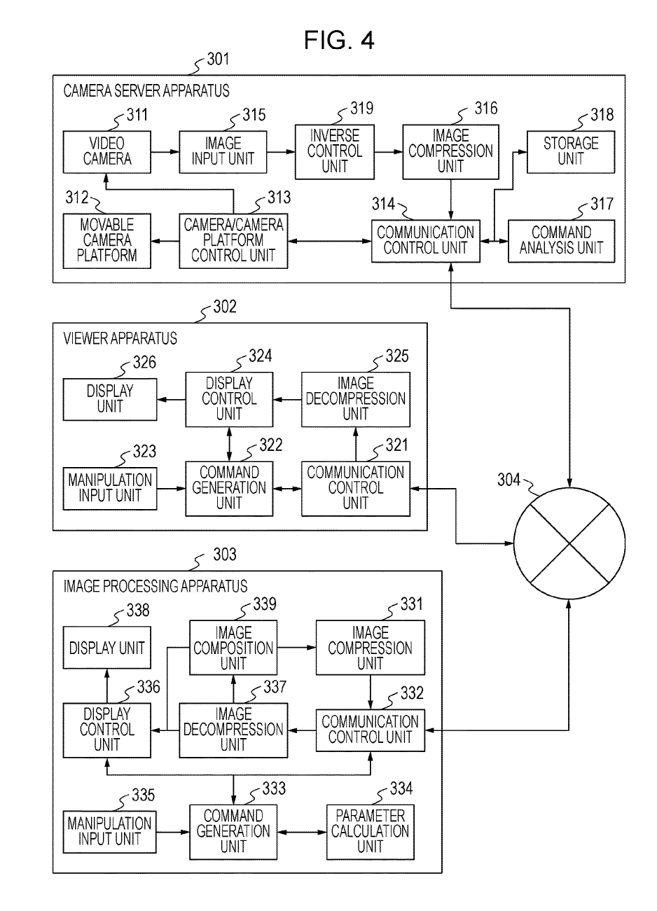

Hereinafter, an image processing apparatus according to the present embodiment is described with reference to the drawings. FIG. 4 is a block diagram of a network camera system in the present embodiment. As illustrated in FIG. 4, the network camera system of the present embodiment is constituted by a camera server apparatus 301, a viewer apparatus 302, and an image processing apparatus 303 connected by a network 304.

Although one camera server apparatus 301, one viewer apparatus 302, and one image processing apparatus 303 are connected to the network 304 in the present embodiment, this configuration is not restrictive. That is, the number of the camera server apparatus 301, the viewer apparatus 302, and the image processing apparatus 303 connected to the network 304 is not limited. Although a TCP/IP (UDP/IP) protocol is used as a network protocol, and an IP address is used as an address of the network 304 in the present embodiment, these are not restrictive. TCP/IP is an abbreviation of Transmission Control Protocol/Internet Protocol, and UDP/IP is an abbreviation of User Datagram Protocol/Internet Protocol. That is, the network 304 may be any digital network, such as the Internet and an intranet, with a sufficient bandwidth to transmit camera control signals and compressed image signals described later. In the present embodiment, the camera server apparatus 301, the viewer apparatus 302, and the image processing apparatus 303 are each allocated with an IP address.

First, the camera server apparatus 301 is described. The camera server apparatus 301 receives a command from the viewer apparatus 302 (i.e., a client) by a communication control unit 314, and transmits captured image data and/or panoramic image data via the network 304. The camera server apparatus 301 executes various types of camera control. Hereinafter, each processing unit of the camera server apparatus 301 is described.

The communication control unit 314 receives various commands and outputs the commands to a subsequent processing unit. A command analysis unit 317 analyzes the command received by the communication control unit 314, and outputs an analysis result to a subsequent processing unit. A camera/camera platform control unit 313 controls (to operate) a video camera 311, a movable camera platform 312, and an inverse control unit 319 in accordance with the analysis result of the command analysis unit 317.

The video camera 311 captures a subject under the control of the camera/camera platform control unit 313, and outputs the captured image (i.e., a moving image and a still image) to a subsequent processing unit. The video camera 311 may capture the subject at a zoom factor under the control of the camera/camera platform control unit 313. The video camera 311 is mounted on the movable camera platform 312 in the present embodiment. The movable camera platform 312 determines an angle in the pan direction, an angle in the tilt direction, a turning (i.e., rolling) angle, and the like under the control of the camera/camera platform control unit 313 and operates.

The image input unit 315 takes in the images captured with the video camera 311. If it is necessary to invert the captured image under the control of the camera/camera platform control unit 313 in the present embodiment, the inverse control unit 319 inverts the captured image input from the image input unit 315, and outputs the inverted image to the image compression unit 316. If it is not necessary to invert the captured image under the control of the camera/camera platform control unit 313 in the present embodiment, the inverse control unit 319 outputs the captured image input from the image input unit 315 to the image compression unit 316. If it is not necessary to invert the captured image under the control of the camera/camera platform control unit 313 in the present embodiment, the captured image input from the image input unit 315 may be input in an image compressing unit 316 not via the inverse control unit 319.

The image compression unit 316 compresses (i.e., encodes) the image inverted by the captured image or the inverse control unit 319 taken in by the image input unit 315 into data size transmittable to the viewer apparatus 302 and/or the image processing apparatus 303. The image compression unit 316 takes in image signals from the video camera 311, A/D converts the signals, compresses the signals using a predetermined image compression encoding system, and transmits the compressed captured image data to the network 304 via the communication control unit 314. Although the image compression unit 316 uses the Motion JPEG or other systems as the image compression encoding system in the present embodiment, the compression encoding system is not limited to the same. A storage unit 318 stores various set values set in the camera server apparatus 301, and various types of data. For example, the storage unit 318 stores panoramic image data generated by the image processing apparatus 303.

Next, the viewer apparatus 302 is described. The viewer apparatus 302 connects to the camera server apparatus 301 via the network 304 by designating the IP address allocated to an arbitrary camera server apparatus 301. Hereinafter, each processing unit of the viewer apparatus 302 is described.

A communication control unit 321 receives the captured image data transmitted via the network 304 from the camera server apparatus 301, and the panoramic image data stored in the storage unit 318. The communication control unit 321 receives information on the result of various types of camera control. An image decompression unit 325 decompresses (i.e., decodes, deploys) the captured image data and panoramic image data received by the communication control unit 321. The display control unit 324 controls to display, on a display unit 326, the captured image and the panoramic image decompressed by the image decompression unit 325. In accordance with the result of the various types of camera control received by the communication control unit 321, the display control unit 324 may control to generate a graphical user interface (GUI) and display on the display unit 326.

A manipulation input unit 323 receives operation information, such as GUI operation, using a mouse and a keyboard, by a user. For example, the manipulation input unit 323 may input GUI operations, such as mouse click on a panoramic image, and dragging of a frame that may designate pan/tilt/roll/zoom of the video camera 311 and the movable camera platform 312. The command generation unit 322 generates control commands for various types of camera control in accordance with operation information input by the manipulation input unit 323. The command generation unit 322 transmits the generated control commands to the camera server apparatus 301 via the communication control unit 321 and the network 304.

The image processing apparatus 303 designates an IP address allocated to the camera server apparatus 301, and connects to the camera server apparatus 301 via the network 304 as the viewer apparatus 302. Hereinafter, each processing unit of the image processing apparatus 303 is described. A communication control unit 332, a command generation unit 333, and a manipulation input unit 335 of the image processing apparatus 303 have the same function as those of the communication control unit 321, the command generation unit 322, and the manipulation input unit 323 of the viewer apparatus 302, respectively. Since a display control unit 336, an image decompression unit 337, and a display unit 338 have the same function as those of the display control unit 324, the image decompression unit 325, and the display unit 326 of the viewer apparatus 302 respectively, description thereof is omitted.

A parameter calculation unit 334 calculates pan/tilt/roll angles in capturing an image used to generate a panoramic image. The panoramic image consists of a plurality of images captured with the video camera 311, and is generated using the images captured with the video camera 311 at a plurality of angles in the pan/tilt directions.

An image composition unit 339 generates the panoramic image by using images which are received from the camera server apparatus 301 via the communication control unit 332 and the network 304, and are decompressed by the image decompression unit 337. An image compression unit 331 compresses the panoramic image generated by the image composition unit 339 into data size transmittable to the camera server apparatus 301, and outputs the compressed panoramic image data to the communication control unit 332. Details of the generation process of the panoramic image are described later.

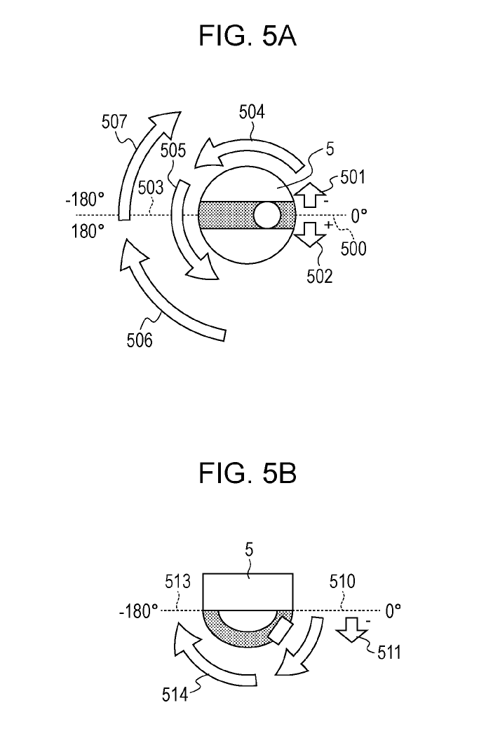

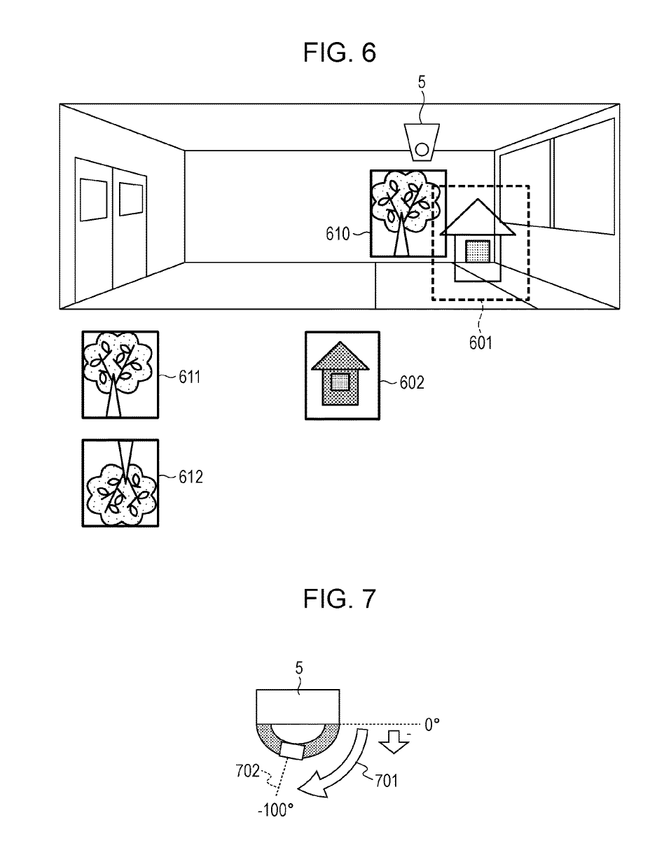

Next, an operation of the camera server apparatus 301 (i.e., the network camera) in the present embodiment is described with reference to FIGS. 5A and 5B. Here, a case where the camera server apparatus 301 is installed in a ceiling of a room (i.e., parallel with the pan direction) as illustrated in FIG. 6, and the camera server apparatus 301 is seen toward an installation surface (seen upward from below) is described.

First, an operation and a moving range in the pan direction of the network camera 5 in the present embodiment are described with reference to FIG. 5A. The network camera 5 can automatically turn while changing capturing directions by panning/tilting/zooming (PTZ). As illustrated by 504, 505, 506 and 507 in the pan direction, the network camera 5 can turn (i.e., change capturing directions) about a predetermined turning axis in the negative direction (−) 501 or the positive direction (+) 502 with the angle (i.e., position) 500 as a reference (0°). The panning angle (i.e., pan position information) of the network camera 5 moves between 180° and −180° with a line 503 as a boundary. That is, when the network camera 5 turns clockwise (i.e., to the right) from the line 503, the pan position information increases from −180° to 0°, and when turns counterclockwise (i.e., to the left) from the line 503, the pan position information decreases from 180 to 0°. That is, the network camera 5 in the present embodiment illustrated in FIG. 5A is turnable from −180° to 180° in the pan direction.

Next, an operation and a moving range in the tilt direction of an image capturing unit of the network camera 5 in the present embodiment are described with reference to FIG. 5B. In the operation in the tilt direction, the network camera 5 can move in the direction 511 with the angle denoted by 510 (i.e., parallel to the pan direction) as a reference (0°), moves as illustrated by 514, and is movable to the angle 513 (−180°). That is, the network camera 5 in the present embodiment illustrated in FIG. 5B is movable between 0° and −180° in the tilt direction. The −90° position in the tilt direction coincides with the position of the turning axis of the pan operation. That is, the network camera 5 performs the tilt operation straddling the turning axis of the pan operation.

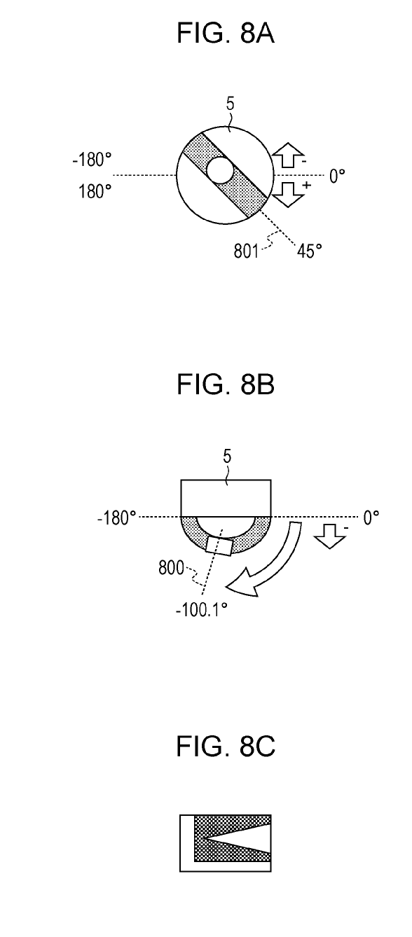

Next, a flip operation of the network camera 5 in the present embodiment is described with reference to FIGS. 6 and 7. FIG. 6 illustrates exemplary installation of the network camera 5 of the present embodiment. In FIG. 6, the network camera 5 is installed in a room, a picture 611 is displayed on a far side wall at the position 610 of the room, and a picture 602 is displayed on a near side wall at the position 601 of the room.

If the network camera 5 faces the near side of the room (i.e., the wall side on which the picture 601 is displayed) in the state illustrated in FIG. 6, when the picture 601 is captured with the network camera 5, the orientation of the captured picture becomes as illustrated by 602. That is, the picture 601 displayed on the wall and the captured picture 602 are the same in up, down, left and right orientations. If the network camera 5 performs only the tilt operation from a state where it faces the near side of the room and moves to the position to capture the far side of the room (i.e., the wall side on which the picture 610 is displayed), when the picture 610 is captured with the network camera 5, the orientation of the captured picture becomes as illustrated by 612. That is, the picture 610 displayed on the wall and the captured picture 612 are inverted in up, down, left and right orientations.

Therefore, the network camera 5 in the present embodiment may change the orientation of the captured image into the orientation of the actual object by inverting the captured image in accordance with the angle in the tilt direction in a manner such that the object in the actual space and the captured object are the same in orientation. The process of inverting the picture upside down (i.e., turning 180°) refers to flipping. When the angle in the tilt direction becomes a predetermined value (i.e., when the angle exceeds the predetermined angle), the network camera 5 in the present embodiment automatically performs a flip operation, which is referred to as an automatic flipping (auto-flipping) operation.

Next, a flipping angle of the network camera 5 in the present embodiment is described with reference to FIG. 7. FIG. 7 illustrates a relationship between the flip operation and the tilt position of the network camera 5 in the present embodiment. In FIG. 7, when the network camera 5 in the present embodiment performs the tilt operation in the direction 701, the network camera 5 performs the flip operation at the angle exceeding an angle 702 (−100°) (i.e., an angle smaller than −100° and not smaller than −180°). With the flip operation, the network camera 5 in the present embodiment inverts the captured image at the angle smaller than −100° and not smaller than −180° in the tilt direction to correct the orientation of the captured image to that of the actual object. Hereinafter, the angle in the tilt direction used as a reference at which the flip operation is performed (−100° in the present embodiment) is referred to as a flip angle.

To prevent the captured image from becoming upside down, the flip operation may be performed when the angle of the network camera 5 exceeds −90° in the tilt direction. However, if the flip operation is performed with −90° in the tilt direction as a boundary, the flip operation may occur frequently when the user instructs panning/tilting of the network camera 5 near −90° in the tilt direction. From this reason above, the flip operation is performed with −100° in the tilt direction as a reference in the network camera 5 of the present embodiment. The network camera of the present embodiment performs the flip operation when the angle in the tilt direction reaches −100°, but this configuration is not restrictive. The angle of the flip operation may be determined in the range from about −90° to about −135° depending on the user's preference or the like.

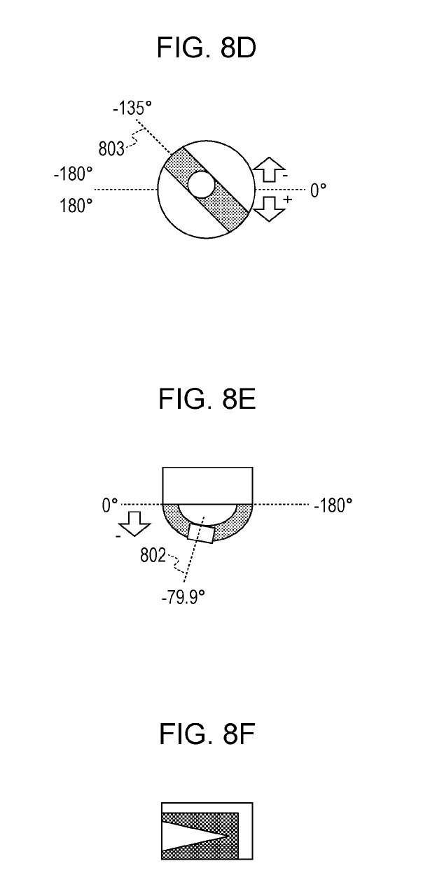

Next, pan/tilt information on the flip operation and the captured image are described with reference to FIGS. 8A to 8F. FIGS. 8A, 8B, and 8C illustrate a case where the tilt angle of the network camera 5 is an angle at which the flip operation is performed (i.e., an angle that exceeds the flip angle). First, a case where the network camera 5 captures an image in the state illustrated in FIGS. 8A and 8B is described. If the angle (i.e., position) in the pan direction is 45° as illustrated in FIG. 8A and the angle in the tilt direction is −100.1° as illustrated in FIG. 8B, an image captured with the network camera 5 is illustrated in FIG. 8C. The image illustrated in FIG. 8C is not flipped (flipping is a process of inverting the captured image).

When the tilt angle exceeds −100°, the network camera 5 in the present embodiment performs the processes as illustrated in FIGS. 8D, 8E, and 8F to perform flipping. FIGS. 8D, 8E, and 8F illustrate a state where flipping is performed from the state of FIGS. 8A, 8B, and 8C. When flipping is performed, an image is inverted as illustrated in FIG. 8F from FIG. 8C. A coordinate system is also inverted when flipping is performed. Specifically, pan position information is updated from the angle 801 (45°) illustrated in FIG. 8A to the angle 803 (−135°) illustrated in FIG. 8D, and tilt position information is updated from the angle 800 (−100.1°) illustrated in FIG. 8B to the angle 802 (−79.9°) illustrated in FIG. 8E. For example, the pan position information is updated in accordance with a value calculated based on the angle in the pan direction after flipping=the angle in the pan direction before flipping +180° (or) −180°. The tilt position information is updated in accordance with the value calculated based on the angle in the tilt direction after flipping=−(the angle in the tilt direction before flipping +180°). The calculating methods of the pan position information and the tilt position information are not limited to those described above. Regarding the flip operation, the captured image may be inverted, or the capturing angle may be inverted by turning (i.e., rolling) the network camera 5 itself.

Here, the image after flipping illustrated in FIG. 8F is captured with the network camera 5 at a position of 45° in the pan direction and −79.9° in the tilt direction, and becomes an image that is not flipped. That is, consistency among the pan position information and the tilt position information, and the image can be achieved by updating the pan position information and the tilt position information as described above. As described above, in the network camera 5 of the present embodiment, the flip operation is performed when the angle in the tilt direction becomes smaller than −100°, and the tilt position information is converted into a greater angle than −80°. Therefore, the tilt position information is always not smaller than −100°.

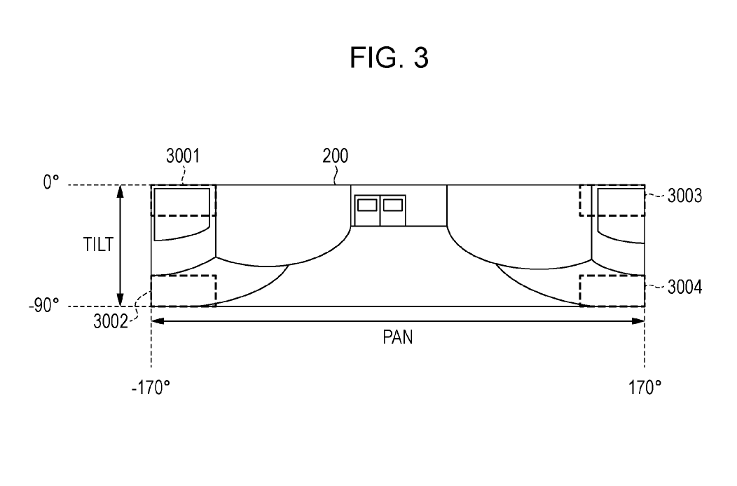

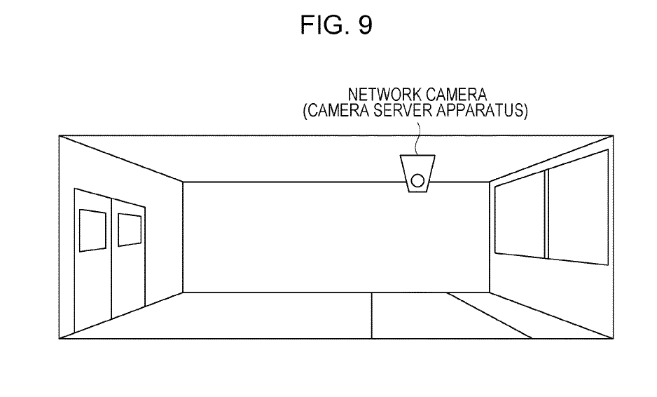

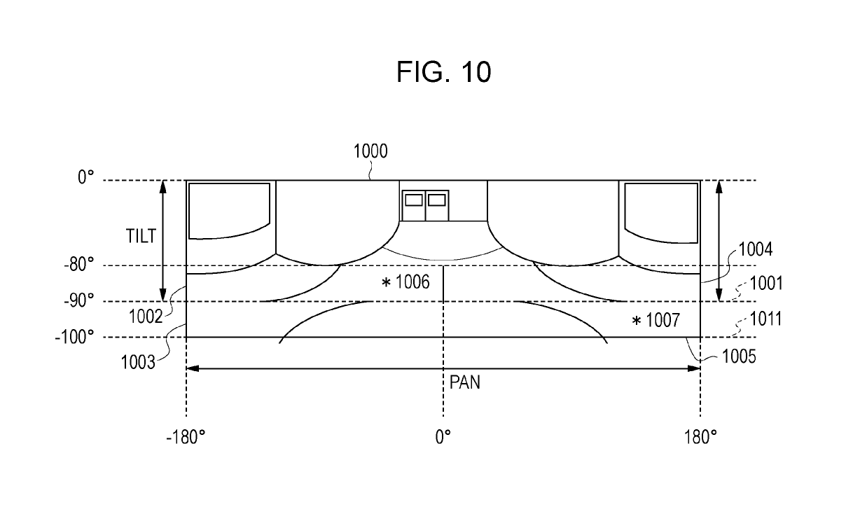

Next, the panoramic image in the present embodiment is described with reference to FIG. 10. In FIG. 10, the reference numeral 1000 denotes a panoramic image generated with the network camera 5 installed as illustrated in FIG. 9. As compared with the related art panoramic image 200 illustrated in FIG. 3, the panoramic image 1000 in the present embodiment illustrated in FIG. 10 has an increased range of the image (i.e., a display area) in the pan direction. This is because the moving range in the pan direction of the network camera 5 is from −180° to 180° in the present embodiment whereas from −170° to 170° in the related art example of FIG. 3: therefore, the network camera 5 of the present embodiment has a wider moving range in the pan direction.

As compared with the panoramic image 200 of the related art example, the panoramic image 1000 of the present embodiment has a wider image range also in the tilt direction. That is, the panoramic image 1000 of the present embodiment is generated by composing images including an image 1011 at −100° in the tilt direction. This is because the method for generating the panoramic image of the present embodiment differs from those of the related art examples in the following viewpoints. In the related art example, the panoramic image 200 is generated at a range from 0° to −90° in accordance with the moving range in the tilt direction of the network camera 5 (from 0° to −90°). In the present embodiment, in contrast, the panoramic image 1000 is generated at the range from 0° to −100° in accordance with −100° which is the flip angle instead of from 0° to −180° which is the tilt range. That is, the range corresponding to the tilt operation of the panoramic image includes a range from 0° which is a start point of the tilt operation to −90° which is the turning axis of the pan operation and, thereafter, does not include −180° which is an end point of the forward direction of the tilt operation (e.g., from 0° to −100°). Regarding the backward direction of the tilt operation, the range includes from a position of −180° which corresponds to a start point to −90° which is the turning axis of the pan operation and, thereafter, does not include 0° which is an end point. The network camera 5 in the present embodiment may express the tilt position information between 0° and −100° by updating the tilt position information when the flip angle is exceeded as illustrated in FIGS. 8A to 8F. The panoramic image 1000 in the present embodiment is generated between 0° and −100°. Therefore, the captured image of the entire pan/tilt moving range of the network camera 5 can be expressed on the panoramic image. As compared with the case where the panoramic image is generated in the range from 0° to −180° in the tilt direction in accordance with the moving range in the tilt direction (between 0° and −180°), the panoramic image with less image overlapping can be generated by the present embodiment.

Here, a method for generating the panoramic image 1000 in FIG. 10 is described. In the present embodiment, a partial panoramic image (i.e., a panoramic image in the range from 0° to −90° in the tilt direction) is generated by moving the network camera 5 in the tilt direction from 0° to −90° (i.e., an angle at which 1001 of FIG. 10 is capturable), and capturing an image between −180° and 180° in the pan direction. Next, a partial image 1002 (from −180° to −0° in the pan direction, from −80° to −90° in the tilt direction) of the generated partial panoramic image is inverted in the tilt direction, and is copied to a range 1005 (from 0° to 180° in the pan direction, from −90° to −100° in the tilt direction). Similarly, a partial image 1004 (from 0° to 180° in the pan direction, from −80° to −90° in the tilt direction) is inverted in the tilt direction, and is copied to a range 1003 (from −180° to 0° in the pan direction, from −90° to −100° in the tilt direction). Thus, an image of the range from −90° to −100° in the tilt direction may be generated by inverting and copying (i.e., replicating) using a partial panoramic image of −80° to −90° in the tilt direction. The panoramic image 1000 may be generated by composing the images of −90° to −100° in the tilt direction generated as described above and the image of 0° to −90° in the tilt direction.

As described above, generation of an image in the range from −90° to −100° in the tilt direction by inverting and copying is more efficient than the method described below. That is, compared with a process in which a partial panoramic image (i.e., a panoramic image in the range from −90° to −100° in the tilt direction) is generated by moving the network camera 5 from −90° to −100° in the tilt direction, and capturing an image between −180° and 180° in the pan direction, time required for the present process is shorter.

The position 1006 (−45° in the pan direction, −85° in the tilt direction) included in 1002 illustrated in FIG. 10 corresponds to the position 1007 (135° in the pan direction, −95° in the tilt direction) included in 1005, and the capturing direction of the network camera 5 is spatially the same.

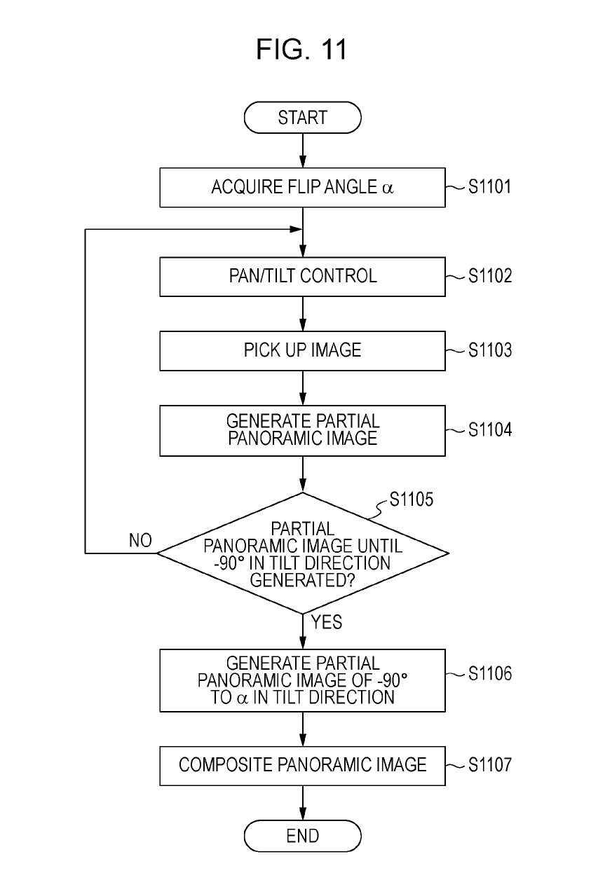

Next, a procedure of generating the panoramic image in the present embodiment is described with reference to FIG. 11. FIG. 11 illustrates a process performed with the camera server apparatus 301 and the image processing apparatus 303 when a panoramic image is generated while the camera server apparatus 301 is made to automatically turn by panning/tilting. Hereinafter, the process of each step illustrated in FIG. 11 is described.

In step S1101, the communication control unit 332 of the image processing apparatus 303 acquires information on the flip angle α of the network camera 5 from the camera server apparatus 301. In the present embodiment, the flip angle α is −100°. In step S1102, the image processing apparatus 303 determines the angles (i.e., positions) in the pan/tilt directions, and transmits a command to the camera server apparatus 301 to instruct the camera server apparatus 301 to perform pan/tilt control. In the present embodiment, the image processing apparatus 303 starts capturing from −180° in the pan direction and 0° in the tilt directions with respect to the camera server apparatus 301, and controls to shift (i.e., change) in the pan direction as capturing proceeds. In step S1103, the image processing apparatus 303 captures images at angles, in the pan/tilt directions with the camera server apparatus 301, determined in step S1102. In step S1104, the image processing apparatus 303 generates (i.e., composes) a partial panoramic image at an angle in the tilt direction determined in step S1102 using the images acquired in step S1103.

In step S1105, the image processing apparatus 303 determines whether the images have been captured at all the angles between 0° and −90° in the tilt direction. That is, in step S1105, the image processing apparatus 303 determines whether the partial panoramic image to the angle (i.e., position) 1001 in FIG. 10 (i.e., the partial panoramic image in the range from 0° to −90° in the tilt direction) has been generated. In step S1106, the image processing apparatus 303 generates a partial panoramic image in the range from −90° to a in the tilt direction. Here, in step S1106, the image processing apparatus 303 generates the image 1005 and the image 1003 illustrated in FIG. 10. In step S1107, after completion in step S1106, the image processing apparatus 303 composes a partial panoramic image in the range from 0° to −90° in the tilt direction generated in step S1104, and a partial panoramic image in the range from −90° to a in the tilt direction generated in step S1106. That is, a panoramic image from 0° in the tilt direction to the flip angle α (i.e., the panoramic image 1000 of FIG. 10) can be generated by performing the compositing process in step S1107.

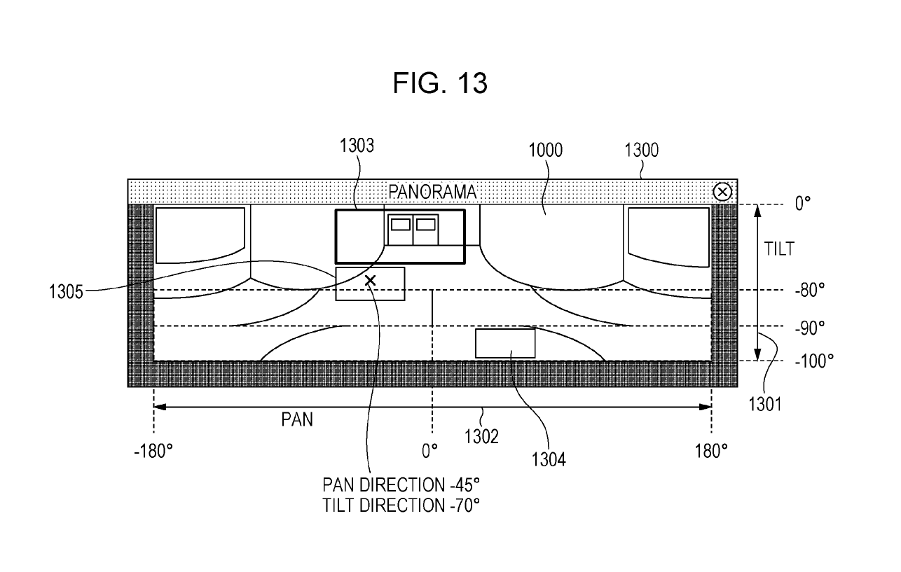

The image processing apparatus 303 transmits the generated panoramic image to the storage unit 318 of the camera server apparatus 301 via the communication control unit 332 of the image processing apparatus 303, and via the communication control unit 314 of the camera server apparatus 301. The storage unit 318 stores the panoramic image generated by the image processing apparatus 303. The viewer apparatus 302 accesses the storage unit 318 of the camera server apparatus 301, and controls an image capturing area of the camera server apparatus 301 using the stored panoramic image. In the present embodiment, for example, the image capturing area of the camera server apparatus 301 is controllable by moving an area 1303 illustrated by a thick frame on the panoramic image 1000 as illustrated in FIG. 13. The area 1303 illustrates the current image capturing area (an outer edge, a frame) of the camera server apparatus 301. Details of FIG. 13 are described later.

By generating the panoramic image in accordance with the flowchart of FIG. 11, a panoramic image based on the flip angle can be acquired. Even in a case where a panoramic image is generated using a revolving unit movable between 180° and −180° in the pan direction and between 0° to −180° in the tilt direction, a panoramic image with less image overlapping can be generated as compared with a case where the panoramic image of the range from 0° to −180° in the tilt direction is generated.

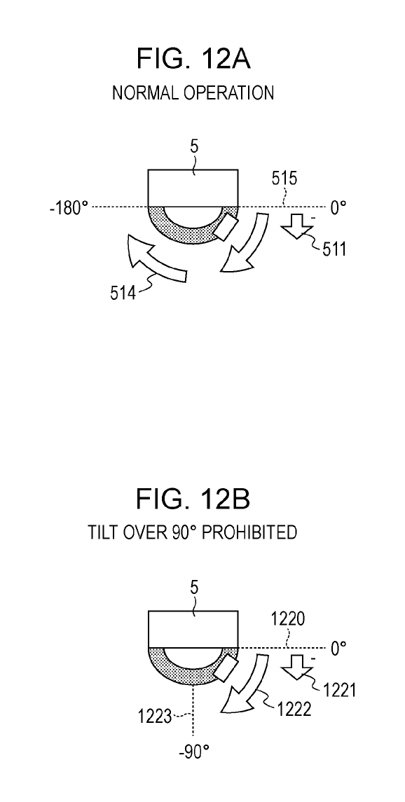

Next, an operation in the tilt direction based on an operation mode set in the network camera 5 of the present embodiment is described with reference to FIGS. 12A and 12B. FIG. 12A illustrates an operation in the tilt direction of the network camera 5 of the present embodiment when a normal mode is set as the operation mode. Since the operation in the pan direction of the network camera 5 in the normal mode illustrated in FIG. 12A is the same as the operation illustrated in FIG. 5A described above, the same reference numerals are used, and description is omitted. FIG. 12B illustrates an operation in the tilt direction of the network camera 5 of the present embodiment when a limit mode is set as the operation mode. As illustrated in FIG. 12B, the network camera 5 can move in the direction 1221 with the angle denoted by 1220 (i.e., parallel to the pan direction) as a reference (0°), moves as illustrated by 1222, and is movable to the angle 1223 (−90°). When the limit mode is set, the operation in the tilt direction of the network camera 5 is restricted to the range from 0° to 90°, whereby a movement toward the direction smaller than −90° in the tilt direction is inhibited. This limit mode can be set in the camera server apparatus 301 in the following manner. For example, the manipulation input unit 323 of the viewer apparatus 302 inputs an instruction about the limit mode by the user, and the command generation unit 322 generates a command about the limit mode in accordance with the instruction. The limit mode may be set by the communication control unit 321 that inputs the generated command in the camera server apparatus 301 via the network 304. The limit mode may also be set in the camera server apparatus 301 by using the image processing apparatus 303.

Next, as illustrated in FIG. 12A, the panoramic image in a case where the normal mode is set in the network camera 5 as the operation mode is described with reference to FIG. 13. As illustrated in FIG. 13, in the present embodiment, the panoramic image 1000 is displayed on a screen 1300 of the display unit 326 of the viewer apparatus 302. The area 1303 illustrated by a thick frame in FIG. 13 illustrates a current image capturing area (an outer edge, a frame) of the network camera 5. When the user instructs the manipulation input unit 323 or the manipulation input unit 335 to move and/or transform (including enlarge and reduce) this area, the network camera 5 may be PTZ controlled and the image capturing area may be set (i.e., changed). The panoramic image 1000 may be displayed on the screen 1300 in FIG. 13, and the area 1303 may be set to the entire panoramic image as illustrated by 1301 and 1302. The area 1303 may be moved between −180° and 180° in the pan direction, and between 0° and −100° in the tilt direction.

By using the method for generating the panoramic image described above, as illustrated in an area 1304 of FIG. 13, the image capturing area may be designated to the flip angle in the tilt direction. Here, an area in which an image equal to an image captured in the range from −90° to −100° in the tilt direction (except for an image of which up, down, left, and right orientations are inverted) is capturable does not exist in the range from 0° to −90° in the tilt direction. For this reason, in the related art panoramic image illustrated in FIG. 3, the user is not able to designate the range from −90° to −100° in the tilt direction as the image capturing area. By using the panoramic image of the present embodiment, a user may designate the range from −90° to −100° in the tilt direction as the image capturing area. For example, if the panoramic image of the present embodiment is used to capture an object moving from −90° to −100° in the tilt direction, the image capturing area may be designated to the angle of flipping. If the object further moves from −100° to −110° in the tilt direction, when the flip angle (−100°) is exceeded, the object is displayed at a position corresponding to from −80° to −70° in the tilt direction in the panoramic image 1000.

The panoramic image 1000 illustrated in FIG. 13 corresponds to the range from 0° to −100° in the tilt direction, whereas the partial image corresponding to the range from −100° to −180° in the tilt direction is equal to the partial panoramic image corresponding to the range from −90° to 0° in the tilt direction. That is, if the user wishes to designate the range smaller than −100° in the tilt direction as the image capturing area, it is only necessary to designate the corresponding angle (position, range) of the tilt direction from −90° to 0° in the tilt direction. For example, if 135° in the pan direction and −100° in the tilt direction are to be designated as the image capturing area, it is only necessary to designate −45° in the tilt direction and −70° in the pan direction as the image capturing area as illustrated in the area 1305 in FIG. 13.

In the present embodiment, as illustrated in the area 1304 of FIG. 13, the panoramic image is generated in a manner such that the range of the tilt angle corresponding to the area 1304 is within the range of the angle smaller than −90° in the tilt direction of the panoramic image 1000. Therefore, the area 1304 may be displayed without interruption in the panoramic image 1000. In the panoramic image from 0° to −90° in the tilt direction, in contrast, the area 1304 is interrupted at −90° when an angle smaller than −90° is to be designated, which makes a user difficult designate an image capturing area.

In a normal method for generating a panoramic image, sequentially captured images are spliced while the image capturing direction is changed in the pan direction and in the tilt direction. In this method, images captured at positions near −90° in the tilt direction tend to be distorted. Therefore, if the user wishes to follow an object moving toward near −90° in the tilt direction, the user may sometimes be difficult to set the area 1304. In the present embodiment, since the panoramic image is generated to the angle smaller than −90° in the tilt direction (i.e., −100°), the user may view to the angle exceeding near −90° at which the image is distorted. Therefore, the user easily set the area 1304 even at the angle near −90°.

In the present embodiment, the flip operation is performed in the tilt direction at an angle smaller than −100°. Therefore, in the present embodiment, the area 1304 may always be displayed on the panoramic image by generating the panoramic image in the range from 0° to −100° in the tilt direction. If the panoramic image is generated only from 0° to −90° in the tilt direction, in contrast, time in which the area 1304 is not displayed on the panoramic image exists immediately after the start of capturing of an angle smaller than −90° (e.g., −90.1°). That is, in the present embodiment, the area 1304 may be displayed on the panoramic image 1000 while capturing at any angles in the tilt direction.

Although the panoramic image 1000 is generated in the range from 0° to −100° in the tilt direction in accordance with the angle at which the flip operation is performed in the present embodiment, this is not restrictive. That is, even in a case where a panoramic image is to be generated using a revolving unit movable between 0° and −180° in the tilt direction, the panoramic image may be generated in the range from 0° to −90° in the tilt direction. Thus, as compared with a case where an image is generated from 0° to −180° in the tilt direction, a panoramic image with less image overlapping can be generated by generating a panoramic image of from 0° to −90°.

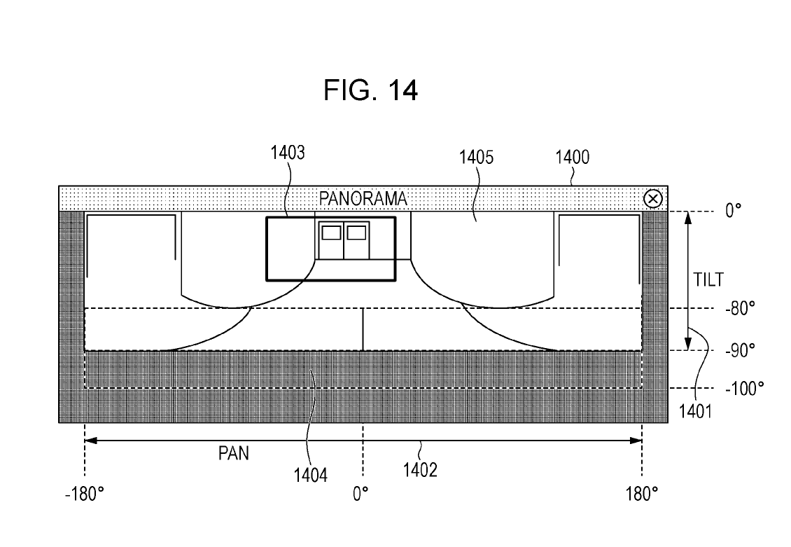

Next, as illustrated in FIG. 12B, a panoramic image when the limit mode is set in the network camera 5 as the operation mode is described with reference to FIG. 14. As illustrated in FIG. 14, in the present embodiment, a panoramic image 1405 is displayed on a screen 1400 of the display unit 326 of the viewer apparatus 302. An area 1403 illustrated as a thick frame in FIG. 14 is a current image capturing area of the network camera 5 similar to the area 1303 in FIG. 13. That is, by moving and/or deforming the area 1403, PTZ control of the network camera 5 may be conducted to set (i.e., changed) the image pickup area. The panoramic image 1405 may be displayed on the screen 1400 in FIG. 14, and the area 1403 may be set as illustrated in 1401 and 1402. That is, the area 1303 may be moved in the range of −180° to 180° in the pan direction, and 0° to −90° in the tilt direction.

In the present embodiment, the network camera 5 for which the limit mode is set, an operation between −90° and −100° in the tilt direction is inhibited. As illustrated in FIG. 14, in the panoramic image 1405 for which the limit mode is set, an area 1404 of the original panoramic image 1000 (in the normal mode) is displayed in black in consideration of the range where the operation is inhibited. Then the user can view the area where the operation is inhibited. The method for displaying the area where operation is inhibited is not limited to the same, but other image processing may be performed. For example, the area 1404 may be painted in other colors, blurred, mosaiced, hatched, or superposed with predetermined image. Alternatively, the area 1404 may be superposed with characters, symbols, or the like by on-screen display (OSD). An image except for the area 1404 (i.e., the area 1404 is eliminated) may be displayed on the screen 1400 as a panoramic image.

Of the panoramic image in the limit mode, a part of the panoramic image in the normal mode may be used for the image other than the range where the operation is inhibited. That is, an image of from 0° to −90° in the tilt direction of the panoramic image 1000 in the normal mode illustrated in FIG. 13 may be used as the image of from 0° to −90° in the tilt direction of the panoramic image 1405 in the limit mode illustrated in FIG. 14.

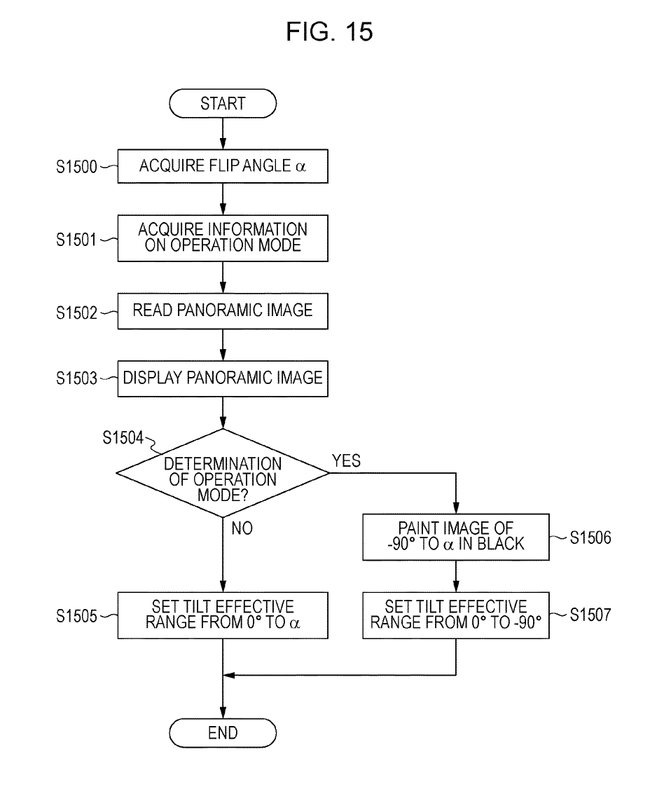

Next, a procedure of the display process of the panoramic image illustrated in FIGS. 13 and 14 is described with reference to FIG. 15. FIG. 15 is a process executed by the viewer apparatus 302 to display a panoramic image. This sequence is executed when, for example, a user uses a panoramic image.

In step S1500, the communication control unit 321 of the viewer apparatus 302 acquires information on the flip angle α of the network camera 5 from the camera server apparatus 301. In the present embodiment, the flip angle α is −100° as in FIG. 11. In step S1501, the viewer apparatus 302 acquires information on the operation mode from the camera server apparatus 301. In step S1502, the viewer apparatus 302 acquires (i.e., reads) the panoramic image from the camera server apparatus 301. In step S1503, the display control unit 324 of the viewer apparatus 302 controls the panoramic image acquired in step S1502 to be displayed on the display unit 326.

In step S1504, the viewer apparatus 302 determines whether the limit mode is set, in accordance with the information on the operation mode acquired in step S1501. If the limit mode is set in the present embodiment, as described above, the operation of the camera server apparatus 301 in the tilt direction shall be restricted to the range from 0° to −90°. That is, in step S1504, the viewer apparatus 302 may acquire inhibition information indicating whether the operation of the camera server apparatus 301 in the tilt direction is restricted to range from 0° to −90°, and may determine whether the operation in the tilt direction is inhibited.

If it is determined in step S1504 that the limit mode (i.e. inhibition of the operation in the tilt direction) has not been set, i.e., that the normal mode has been set (step S1504: NO), the viewer apparatus 302 proceeds to the process of step S1505. In step S1505, the viewer apparatus 302 sets the range in which the panoramic image is displayable to from 0° to a (−100°). Then the display control unit 324 of the viewer apparatus 302 controls the panoramic image 1000 to be displayed on the display unit 326 as illustrated in FIG. 13. The display unit 326 displays the panoramic image 1000, and terminates the display process of the panoramic image.

If it is determined that the limit mode is set in step S1504 (step S1504: YES), the viewer apparatus 302 proceeds to the process of step S1506. In step S1506, the viewer apparatus 302 performs a non-display process (e.g., paints in black) as described in FIG. 14 to the range in which the operation is inhibited in the tilt direction (i.e., the range of −90° to a in the tilt direction illustrated in the area 1403 of FIG. 14), and proceeds to step S1507. In step S1507, the viewer apparatus 302 sets the range in which the panoramic image is displayable to from 0° to −90°. Then the display control unit 324 of the viewer apparatus 302 controls the panoramic image 1405 to be displayed on the display unit 326 as illustrated in FIG. 14. The display unit 326 displays the panoramic image 1405 and terminates the display process of the panoramic image.

The network system in the present embodiment may provide a panoramic image with high visibility and reduced overlapping areas in the image capturing apparatus (e.g., a revolving unit) that is operable not less than 90° in the tilt direction from an installation surface. User convenience may be improved by displaying the generated panoramic image.

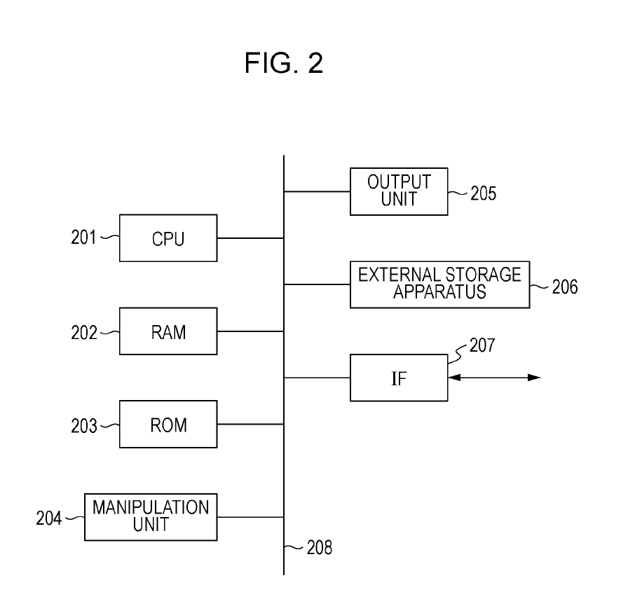

Hereinafter, a second embodiment is described with reference to the drawings. In the above description of the embodiment, each of the processing units of the camera server apparatus 301, the viewer apparatus 302, and the image processing apparatus 303 illustrated in FIG. 4 is configured by hardware. Regarding each processing unit illustrated in FIG. 4, processes other than the processes performed in the video camera 311, the movable camera platform 312, display unit 326, and the display unit 338 may be configured by a computer program. Hereinafter, the present embodiment is described with reference to FIG. 2. FIG. 2 is a block diagram illustrating an exemplary configuration of a computer hardware applicable to an image processing system according to the above embodiment.

A CPU 201 controls the entire computer using the computer program and data stored in RAM 202 or ROM 203, and executes each process described above to be performed by the image processing system according to the above embodiment. That is, the CPU 201 functions as each processing unit illustrated in FIG. 2.

The RAM 202 has an area for temporarily storing the computer program and data loaded from an external storage apparatus 206, data acquired from the outside via an interface (I/F) 207, and the like. The RAM 202 has a work area used when the CPU 201 executes various processes. For example, the RAM 202 can be allocated as picture memory, or can be used as various other areas.

Setting data of this computer, boot program, and the like, are stored in the ROM 203. A manipulation unit 204 is constituted by, for example, a keyboard, and a mouse, and various instructions can be input in the CPU 201 when operated by a user of the computer. An output unit 205 displays a process result by the CPU 201. The output unit 205 is formed, for example, by a liquid crystal display.

The external storage apparatus 206 is large capacity information storage apparatus such as a hard disk drive apparatus. An operating system (OS), and computer programs that cause the CPU 201 to implement the function of each unit illustrated in FIG. 2 are stored in the external storage apparatus 206. Image data as a process target may be stored in the external storage apparatus 206.

The computer programs and data stored in the external storage apparatus 206 are loaded to the RAM 202 under the control of the CPU 201, and are processed by the CPU 201. Networks, such as the LAN and the Internet, and other apparatuses, such as a projection apparatus and a display apparatus, may be connected to the I/F 207. This computer can acquire or transmit various types of information via the I/F 207. The reference numeral 208 denotes a bus connecting each unit described above.

In the operation of the above-described configuration, the CPU 201 mainly controls the process described in the above-described flowchart.

In the first embodiment, the image processing apparatus 303 does not necessarily include all of the processing units illustrated in FIG. 4. For example, the display control unit 336 and/or the display unit 338 may be excluded from the image processing apparatus 303. Alternatively, the processing unit of the image processing apparatus 303 may be included in the camera server apparatus 301. In that case, the camera server apparatus generates a panoramic image and/or performs display control of the panoramic image.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s).

The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-232193, filed Nov. 14, 2014 which is hereby incorporated by reference herein in its entirety.

1. An image processing apparatus, comprising:
an acquisition unit configured to acquire an image captured by an image capturing unit that can change capturing directions by turning in a pan direction and a tilt direction; and
a generating unit configured to generate, using images acquired by the acquisition unit, a panoramic image corresponding to a range capturable by the image capturing unit by turning in the pan direction and the tilt direction, wherein
the generating unit generates the panoramic image of which a range is from a tilt start point in the tilt direction to a predetermined point exceeding a point corresponding to a turning axis of the pan direction, and the range does not include a tilt end point in the tilt direction.

2. The image processing device according to claim 1, further comprising an inverting unit configured to turn the image captured by the image capturing unit upside down, if a turning angle of the image capturing unit in the tilt direction exceeds a predetermined angle exceeding an angle corresponding to the turning axis of the pan direction, wherein the predetermined point is a point corresponding to the predetermined angle.

3. The image processing device according to claim 1, wherein:
the image capturing unit is capable of capturing images while changing capturing directions in the pan direction from −180° to 180°; and
the generating unit generates the panoramic image using a plurality of images captured by the image capturing unit.

4. The image processing apparatus according to claim 1, further comprising a display control unit configured to control a panoramic image generated by the generating unit to be displayed on a display unit.

5. The image processing apparatus according to claim 1, wherein the generating unit generates the panoramic image in accordance with information on limitation in the capturing directions of the image capturing unit.

6. The image processing apparatus according to claim 1, wherein the generating unit performs image processing to a range based on the information on the limitation in the capturing directions of the image capturing unit of the panoramic image.

7. The image processing apparatus according to claim 4, wherein the display control unit controls a display area of the panoramic image generated by the generating unit in accordance with the information on the limitation in the capturing directions of the image capturing unit.

8. The image processing device according to claim 1, wherein:
the tilt start point in the tilt direction corresponds to an angle 0° in the tilt direction;
the turning axis of the pan direction corresponds to an angle 90° in the tilt direction.

9. The image processing device according to claim 1, further comprising the image capturing unit.

10. An image processing method, comprising:
acquiring an image captured by an image capturing unit that can change capturing directions by turning in a pan direction and a tilt direction; and
generating, using images acquired by acquiring, a panoramic image corresponding to a range capturable by the image capturing unit by turning in the pan direction and the tilt direction, wherein
the generating unit generates the panoramic image of which a range is from a tilt start point in the tilt direction to a predetermined point exceeding a point corresponding to a turning axis of the pan direction, and the range does not include a tilt end point in the tilt direction.

11. A non-transitory computer-readable storage medium storing computer executable instructions that cause a computer to execute an image processing method, comprising:
acquiring an image captured by an image capturing unit that can change capturing directions by turning in a pan direction and a tilt direction; and
generating, using images acquired by acquiring, a panoramic image corresponding to a range capturable by the image capturing unit by turning in the pan direction and the tilt direction, wherein
the generating unit generates the panoramic image of which a range is from a tilt start point in the tilt direction to a predetermined point exceeding a point corresponding to a turning axis of the pan direction, and the range does not include a tilt end point in the tilt direction.
